(19) United States
(12) Patent Application Publication
(10) Pub. No.: US 2015/0261599 A1
(43) Pub. Date: Sep. 17, 2015

(54) DATA COMMUNICATION DEVICE, DATA COMMUNICATION SYSTEM AND DATA COMMUNICATION METHOD

(71) Applicant: NEC Corporation, Tokyo (JP)

(72) Inventor: Kentaro HARA, Tokyo (JP)

(73) Assignee: NEC CORPORATION, Tokyo (JP)

(21) Appl. No.: 14/658,586

(22) Filed: Mar. 16, 2015

(30) Foreign Application Priority Data
Mar. 17, 2014 (JP) 2014-053295

(51) Int. Cl. G06F 11/07; H04L 1/00

(52) U.S. Cl. CPC G06F 11/0793; G06F 11/076; G06F 11/0709; H04L 1/009

(57) ABSTRACT

A data communication device includes a plurality of ports for transmitting and receiving a plurality of data strings for which sequential order is specified, transmitting means for transmitting the plurality of data strings through a predetermined port, device information collecting means for collecting information about the plurality of ports and a plurality of ports of a remote device, error occurrence predicting means for predicting the frequency of occurrence of transmission errors at each port, outputting a double-transmission instruction for the detected port to the transmitting means when detecting a port for which a rise in the frequency of occurrence of transmission errors has been predicted. When the double-transmission instruction is input, the transmitting means transmits two or more instances of last data of a plurality of data strings when the transmitting means transmits data strings through the detected port.

### INCORPORATION BY REFERENCE

This application is based upon and claims the benefit of priority from Japanese Patent Application No. 2014-053295, filed on Mar. 17, 2014, the disclosure of which is incorporated herein in its entirety by reference.

### BACKGROUND OF THE INVENTION

1. Technical Field

The present invention relates to a data communication device, a data communication system and a data communication method.

2. Background Art

In a fibre channel (FC) communication, one sequence is transmitted in one or more frames. The receiving end recognizes the completion of the transmission of a series of frames by receiving the last frame containing the last data string.

The section “(8) Class 3 data transmission” on page 63 of “Fibre Channel Technical Guide II (edited and written by JDSF Fibre Channel Industry Association)” states that in class 3 FC communication, an ACK (ACKnowledgement) response in frame transmission is not defined. For this reason, when a frame transmission error occurs in a transmission channel, not only does the frame fail to reach the receiving end but also the sending end cannot recognize the transmission error.

When a frame transmission error occurs and a frame “other than the last frame” is lost in class 3 FC communication, the transmission of a series of frames ends upon reception of the last frame at the receiving end even though the receiving end has not received the lost frame. Then an upper layer, such as the SCSI (Small Computer System Interface) layer, at the receiving end can recognize the frame loss and send back an error response to the sending end to prompt the sending end to retransmit the frame.

However, if the “last frame” is lost in the technique described above, no reply occurs. Specifically, if the “last frame” is lost, the receiving end enters a last-frame wait state and the sending end enters a response wait state because no ACK response exists in class 3 FC communication. Thus the frame transmission stops. This state appears to the upper layer to be a no-response state in which a reply to an I/O (Input/Output) issued is not sent back.

If such a no-response state occurs, the response wait state times out in an upper layer such as the SCSI layer after no response has been received for 30 or 60 seconds, for example, and a retransmission process is executed. However, the I/O suspends at least until the timeout.

### SUMMARY

An object of the present invention is to provide a data communication device, a data communication system and a data communication method that are capable of preventing a no-response state when last data is lost, without adversely affecting the bandwidth for data communication.

A data communication device according to an exemplary aspect of the invention includes a plurality of ports for transmitting and receiving a plurality of data strings for which sequential order is specified, transmitting means for transmitting the plurality of data strings through a predetermined port among the plurality of ports, device information collecting means for collecting information about the plurality of ports and a plurality of ports of a remote device to and from which data strings are transmitted and received, error occurrence predicting means for predicting the frequency of occurrence of transmission errors at each port on the basis of the collected information and instructing means for, when a port for which a rise in the frequency of occurrence of transmission errors has been predicted is detected, outputting a double-transmission instruction for the detected port to the transmitting means. When the double-transmission instruction is input, the transmitting means transmits two or more instances of last data of a plurality of data strings when the transmitting means transmits data strings through the detected port.

A data communication system according to an exemplary aspect of the invention includes a first data communication device and a second data communication device, each of the first and second data communication devices comprising a plurality of ports for transmitting and receiving a plurality of data strings for which sequential order is specified and a management controller. The management controller includes device information collecting means for collecting information about the plurality of ports of the first data communication device and the second data communication device, error occurrence predicting means for predicting the frequency of occurrence of transmission errors at each of the plurality of ports of the first data communication device and the second data communication device on the basis of the collected information and instructing means for, when a port for which a rise in the frequency of occurrence of transmission errors has been predicted is detected, transmitting a double-transmission instruction for the detected port to the data communication device including the detected port. The data communication device that has received the double-transmission instruction transmits two or more instances of last data of a plurality of data strings when transmitting data strings through the detected port.

A data communication method according to an exemplary aspect of the invention is for transmitting and receiving a plurality of data strings for which sequential order is specified through a predetermined port among a plurality of ports. The communication method includes collecting information about the plurality of ports, predicting the frequency of occurrence of transmission errors for each of the ports on the basis of the collected information, when a port for which a rise in the frequency of occurrence or transmission errors has been predicted is detected, setting a double-transmission instruction for the detected port and when data strings are transmitted through the port for which the double-transmission instruction is set, transmitting two or more instances of last data of a plurality of data strings.

### BRIEF DESCRIPTION OF THE DRAWINGS

Exemplary features and advantages of the present invention will become apparent from the following detailed description when taken with the accompanying drawings in which:

FIG. 1 is a block configuration diagram of a data communication device 100 according to a first exemplary embodiment;

FIG. 2 is an operation flow diagram illustrating an operation procedure of the data communication device 100 according to the first exemplary embodiment;

FIG. 3 is a system configuration diagram of a data communication system 2000 according to a second exemplary embodiment;

FIG. 4 is a diagram illustrating a structure of an FC frame header according to the second exemplary embodiment;

FIG. 5 is a system configuration diagram focusing on ports at both ends of one link of a data communication system 2000 according to a third exemplary embodiment;

FIG. 6 is a diagram illustrating information stored in a management table 114b according to the third exemplary embodiment;

FIG. 7 is an operation flow diagram illustrating an operation procedure of the data communication system 2000 according to the third exemplary embodiment;

FIG. 8 is an operation flow diagram illustrating an operation procedure of the data communication system 2000 according to the third exemplary embodiment;

FIG. 9 is an operation flow diagram illustrating an operation procedure of the data communication system 2000 according to the third exemplary embodiment;

FIG. 10 is an operation flow diagram illustrating an operation procedure of the data communication system 2000 according to the third exemplary embodiment;

FIG. 11 is a diagram illustrating a transmission flow in Rapid and Reliable Data Delivery and TCP/IP;

FIG. 12 is a system configuration diagram of a data communication system 3000 according to a fourth exemplary embodiment;

FIG. 13 is an operation flow diagram illustrating an operation procedure of the data communication system 3000 according to the fourth exemplary embodiment;

FIG. 14 is a diagram illustrating a transmission flow in TCP/IP; and

FIG. 15 is a diagram illustrating a transmission flow in TCP/IP.

### EXEMPLARY EMBODIMENT

Exemplary embodiments of the present invention will now be described in detail in accordance with the accompanying drawings.

### First Exemplary Embodiment

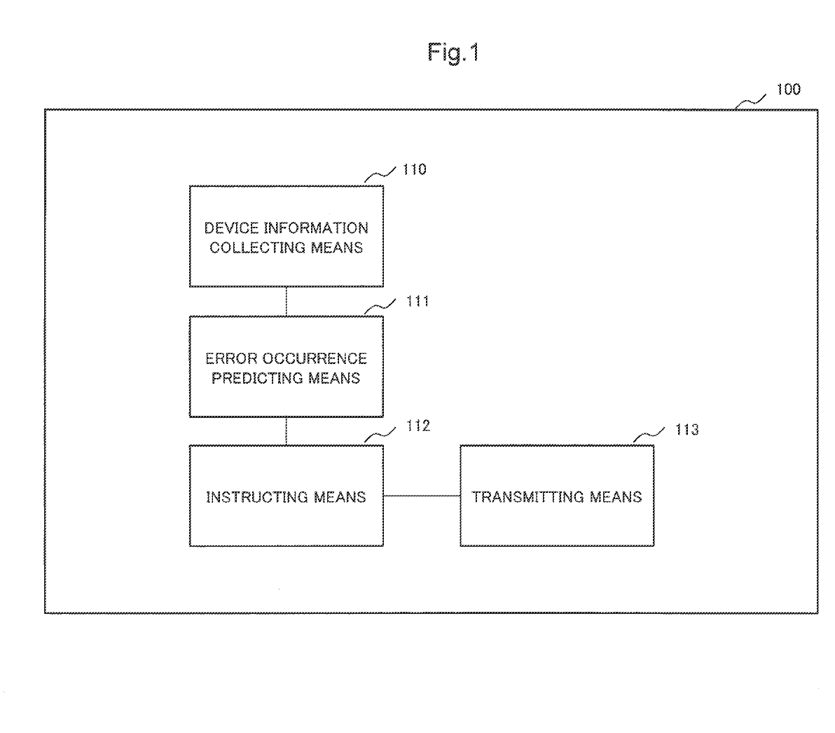

A mode in which data is transmitted in frame-basis will be described in a first exemplary embodiment. FIG. 1 illustrates a block configuration diagram of a data communication device 100 according to this exemplary embodiment. The data communication device 100 includes device information collecting means 110, error occurrence predicting means 111, instructing means 112 and transmitting means 113. The data communication device 100 transmits a plurality of frames for which sequential order is specified to another data communication device through the transmitting means 113.

The device information collecting means 110 collects information about the states of the ports of the data communication device 100 and another data communication device at regular intervals. The method for collecting the information may be to poll by the device information collecting means 110 or to receive information transmitted from device information transmitting means of each device at regular intervals. Alternatively, an administrator of a data communication system may enter information about the state of each port in the device information collecting means 110.

The error occurrence predicting means 111 predicts a rise in the frequency of occurrence of transmission errors at each port on the basis of information collected by the device information collecting means 110.

The instructing means 112 instructs the transmitting means 113 to change the operation mode to a multi-transmission mode when the error occurrence predicting means 111 predicts that the frequency of occurrence of errors will rise. In particular, the instructing means 112 instructs the transmitting means 113 to transmit two or more instances of a last frame. The last frame is the last one of a plurality of frames for which sequential order is specified.

The transmitting means 113 transmits two or more instances of the last frame when the transmitting means 113 is instructed to change to the multi-transmission mode by the instructing means 112.

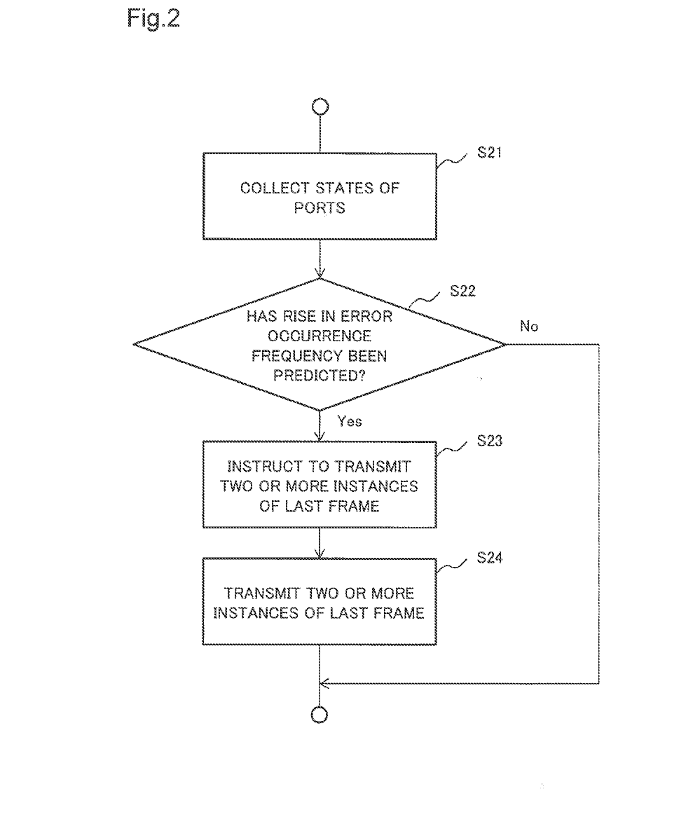

An operation of the data communication device 100 will be described next with reference to FIG. 2.

The device information collecting means 110 collects information about the state of each port of the data communication device 100 and another data communication device at regular intervals (step S21). The error occurrence predicting means 111 predicts the frequency of occurrence of transmission errors at each port on the basis of the information collected by the device information collecting means 110. When the error occurrence predicting means 111 predicts a rise in the frequency of occurrence of transmission errors (Yes at step S22), the instructing means 112 instructs the transmitting means 113 to transmits two or more instances of the last frame (step S23). This causes the transmitting means 113 to transmit two or more instances of the last frame (step S24). On the one hand, when a rise in the frequency of occurrence of transmission errors is not predicted (No at step S22), the transmitting means 113 does not transmit more than one instance of the last frame.

In the data communication device 100 according to this exemplary embodiment, when the error occurrence predicting means 111 predicts the rise in the frequency of occurrence of transmission errors, the transmitting means 113 transmits two or more instances of the last frame. Transmitting two or more instances of the last frame allows the device receiving the last frame to complete reception, even when one of the instances of the last frame have been lost, by using another instance of the last frame that has not been lost. Consequently, occurrence of no-response states due to last-frame losses can be reduced. Furthermore, transmitting two or more instances of the last frame alone does not adversely affect the bandwidth of the FC communication.

When the device on the receiving end that receives the transmitted two or more instances of the last frame which contain the same information, the device holds one of the instances of the last frame and discards the other instance or instances of the last frames.

### Second Exemplary Embodiment

Data is also transmitted in frames in a second exemplary embodiment. FIG. 2 illustrates a system configuration diagram of a data communication system 2000 according to this exemplary embodiment. In the data communication system 2000, means equivalent to the device information collecting means 110, the error occurrence predicting means 111, and the instructing means 112 are disposed in a management controller 800. Note that double-transmission instructing means 112b is provided in this exemplary embodiment as means equivalent to the instructing means 112 and two or more instances of a last frame are transmitted in succession (double-transmission).

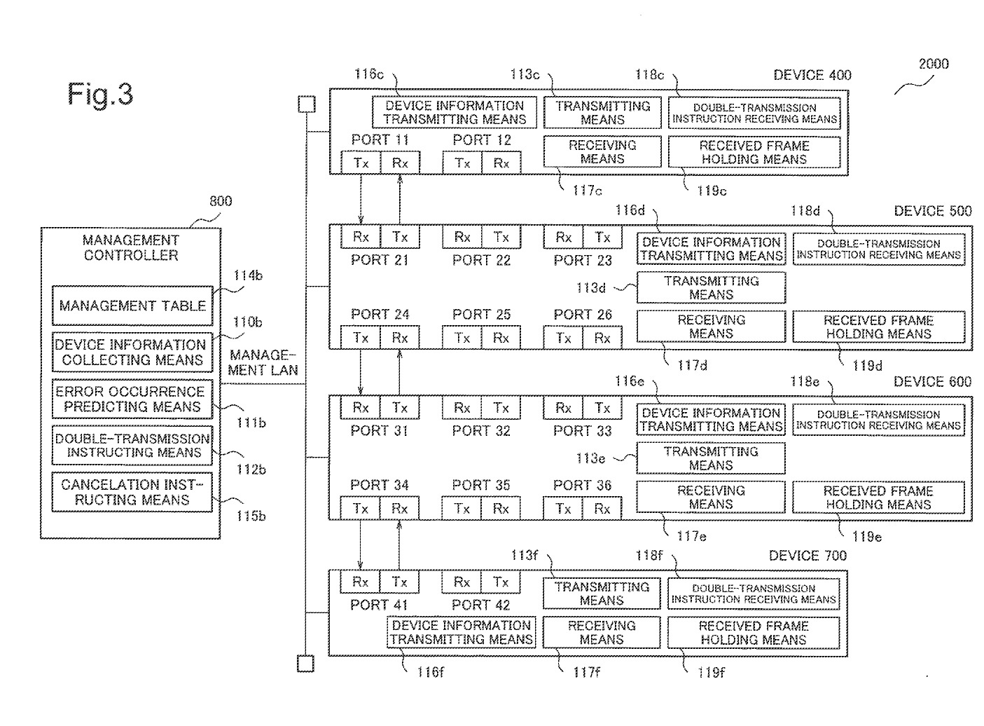

As illustrated in FIG. 3, the data communication system 2000 includes the management controller 800 and devices 400, 500, 600 and 700. The devices 400, 500, 600 and 700 may be a server, an FC switch, a storage and the like.

The management controller 800 includes device information collecting means 110b, error occurrence predicting means 111b, double-transmission instructing means 112b, a management table 114b and cancelation instructing means 115b.

The device information collecting means 110b collects information about the states of ports of the devices 400, 500, 600 and 700 and holds the information in the management table 114b. The method for collecting information is to poll by the device information collecting means 110b or to receive information transmitted from device information transmitting means 116c, 116d, 116e and 116f of the devices 400, 500, 600 and 700 at regular intervals. Alternatively, an administrator of the data communication system 2000 may store information about the states of ports of the devices 400, 500, 600 and 700 in the device information collecting means 110b.

The error occurrence predicting means 111b predicts a rise in the frequency of occurrence of transmission errors at each port on the basis of the information held in the management table 114b.

When the error occurrence predicting means 111b predicts that the frequency of occurrence of transmission errors at a port will rise, the double-transmission instructing means 112b issues a double-transmission instruction for doubly transmitting a last frame to the device that includes the port and the device that includes the corresponding remote port. The double-transmission instruction includes information about the ports for which the double-transmission instruction is issued.

When a port for which a double-transmission instruction has been issued is back to normal in the device information collecting means 110b, the cancelation instructing means 115b issues a double-transmission cancelation instruction for canceling the double-transmission instruction to the device that includes the port and the device that includes the corresponding remote port. The double-transmission cancelation instruction includes information about the ports for which the double-transmission cancelation instruction is issued.

The devices 400, 500, 600 and 700 respectively include device information transmitting means 116c, 116d, 116e and 116f, double-transmission instructing means 118c, 118d, 118e and 118f, received frame holding means 119c, 119d, 119e and 119f, transmitting means 113c, 113d, 113e and 113f, and receiving means 117c, 117d, 117e and 117f.

The device information transmitting means 116c, 116d, 116e and 116f (hereinafter labeled with 116) transmits information about the status of each of their local ports to the management controller 800 at regular intervals.

When the double-transmission instruction receiving means 118c, 118d, 118e and 118f (hereinafter labeled with 118) receive a double-transmission instruction from the management controller 800, the double-transmission instruction receiving means 118 instructs the transmitting means 113 and the receiving means 117 to change the operation mode of the relevant ports that are contained in the double-transmission instruction to a double-transmission mode. On the other hand, when the double-transmission instruction receiving means 118 receives a double-transmission cancelation instruction from the management controller 800, the double-transmission instruction receiving means 118 instructs the transmitting means 113 and the receiving means 117 to change the operation mode of the relevant ports contained in the double-transmission cancelation instruction back to a normal mode.

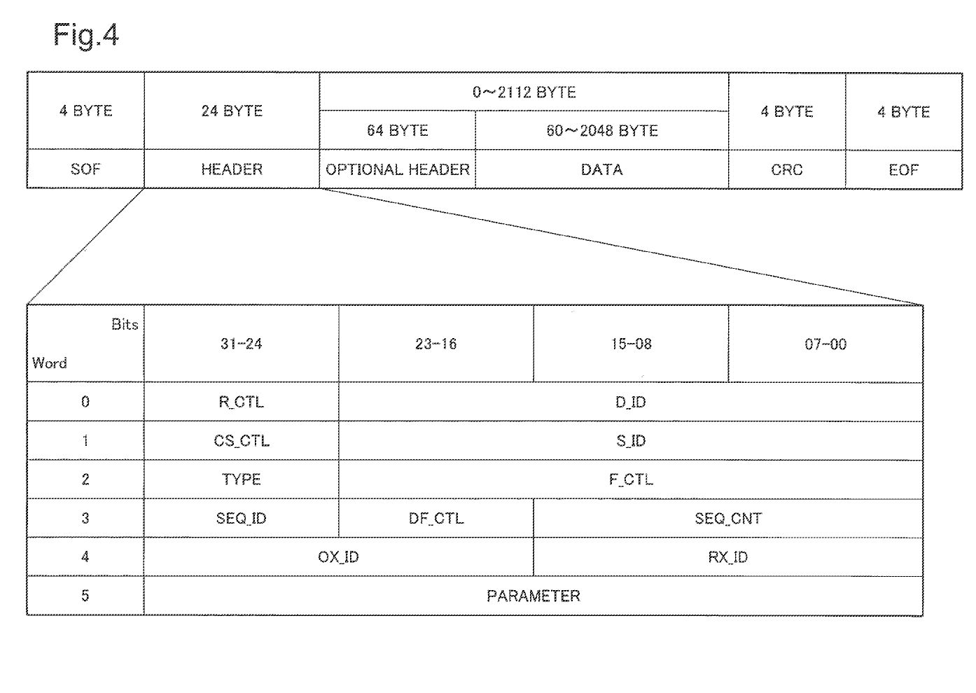

The received frame holding means 119c, 119d, 119e and 119f (hereinafter labeled with 119) holds header information of frames received by the receiving means 117c, 117d, 117e and 117f. A structure of the FC frame header held in the received frame holding means 119 is illustrated in FIG. 4.

In FIG. 4, D_ID is the destination port address, S_ID is the source port address, F_CTL is values representing attributes of an exchange and a sequence (representing whether the frame is the first frame or the last frame, whether the sending end is the originator or the responder, and the like). SEQ_ID is a number unique to each sequence for a pair of SEQ_ID and D_ID. SEQ_CNT is serial numbers of a plurality of frames in one sequence or serial numbers of a plurality of sequences in one exchange, OX_ID is an exchange number issued by the originator, RX_ID is an exchange number issued by the responder.

In a state that the double-transmission mode has been set for relevant ports, when a frame is to be transmitted, the transmitting means 113c, 113d, 113e and 113f (hereinafter labeled with 113) performs a transmission process according to an “End_Sequence” bit in the F_CTL field of the header of a transmission frame. When the double-transmission mode of the relevant ports is canceled, the transmitting means 113 ends the last-frame double-transmission operation. An operation of the transmitting means 113 performed when the double-transmission mode is set for relevant ports will be described below.

When the “End_Sequence” bit in the F_CTL field is 1, it means that the frame to be transmitted is the last frame of the sequence. In that case, the transmitting means 113 transmits two instances of the frame in succession. Since the transmission is successive transmissions onto the link between adjacent nodes, the transmission of the two instances of the same frame is not interrupted by transmission of another frame.

On the other hand, when the “End_Sequence” bit in the F_CTL field is 0, it means that the frame to be transmitted is not the last frame of the sequence. In that case, the transmitting means 113 transmits only one instance of the frame.

In a state that the double-transmission mode has been set for relevant ports, when a frame is to be transmitted, the receiving means 117c, 117d, 117e and 117f (hereinafter labeled with 117) performs a receiving process according to the “End_Sequence” bit in the F_CLT field of the header of a received frame. When the double-transmission mode of the relevant ports is canceled, the receiving means 117 ends an operation for checking double reception of a last frame and discarding a doubly received last frame, which will be described below. An operation of the receiving means 117 performed when the double-transmission mode is set for relevant ports will be described below.

When the “End_Sequence” bit in the F_CTL field is 1 and header information is held in the received frame holding means 119, the receiving means 117 compares the header information of the received frame with the header information held in the received frame holding means 119. If the two match, the receiving means 117 determines that the received frame is a “second frame of doubly transmitted frames”, discards the received frame, and clears the header information held in the received frame holding means 119.

On the other hand, if the two do not match, the receiving means 117 determines that the previously received one of the last frames has been lost and the received frame is the first instance of the last frame of another sequence. In this case, the receiving means 117 updates the information held in the received frame holding means 119 with the header information of the received frame and handles the received frame in a normal manner.

Furthermore, if the “End_Sequence” bit in the F_CTL field is 1 and header information is not held in the received frame holding means 119, the receiving means 117 determines that the received frame is the “first one of doubly transmitted frames”. In this case, the receiving means 117 places the header information of the received frame in the received frame holding means 119 and handles the received frame in a normal manner.

On the other hand, if the “End_Sequence” bit in the F_CTL field is 0, the receiving means 117 clears the frame header information held in the received frame holding means 119 and handles the received frame in a normal manner.

Note that the determination as to whether two frames received in succession are identical to each other is made by comparing the entire frame header (24 bytes) or comparing part of the header information (such as D_ID, S_ID, SEQ_ID, OX_ID, and RX_ID) with which the uniqueness of the frame can be identified.

As has been described, when the error occurrence predicting means 111b of the management controller 800 in the data communication system 2000 according to this exemplary embodiment predicts a rise in the frequency of occurrence of transmission errors, the mode of relevant ports is changed to the double-transmission mode. This causes the transmitting means 113 to transmit two or more instances of the last frame in accordance with the value of the “End_Sequence” bit in the F_CTL field. Transmitting two or more instances of the last frame allows the last frame receiving device to complete the reception by using one of the last frames that has not been lost even if the rest of the last frames has been lost. Consequently, occurrence of no-response states due to last frame losses can be reduced. Furthermore, transmitting two or more instances of the last frame alone does not adversely affect the bandwidth of FC communication.

Note that when the double-transmission instruction receiving means 118 in any of the devices 400, 500, 600, 700 has not received the double-transmission cancelation instruction and a port operating in the double-transmission mode is linked down, the devices 400, 500, 600, 700 end the last-frame double-transmission operation at the relevant port.

When the double-transmission mode is canceled due to a reason other than the instruction from the management controller 800, the device information collecting means 110b collects information about the states of the ports from the device information transmitting means 116 of the devices to enable the management controller 800 to detect the cancelation of the double-transmission mode.

### Third Exemplary Embodiment

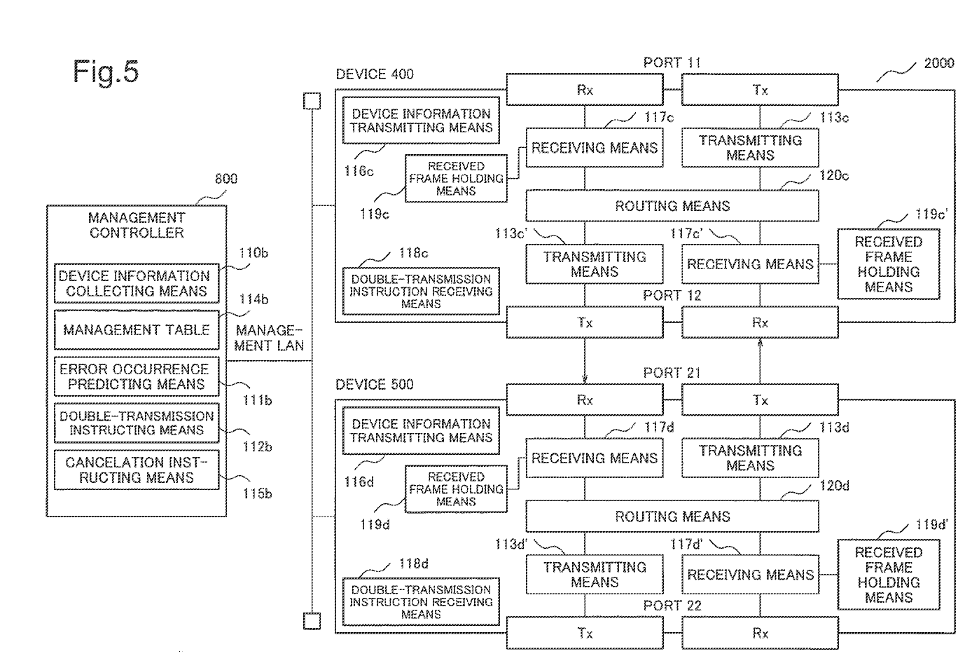

A third exemplary embodiment will be described. FIG. 5 illustrates a system configuration diagram of a data communication system 2000 according to this exemplary embodiment. In this exemplary embodiment, devices 400 and 500 and a management controller 800 are interconnected through a management LAN (Local Area Network) and a port 12 of the device 400 and a port 21 of the device 500 are interconnected through an FC cable.

The management controller 800 has a configuration similar to that of the management controller 800 illustrated in FIG. 3 which is described in the second exemplary embodiment. The following description will focus on the differences from the second exemplary embodiment.

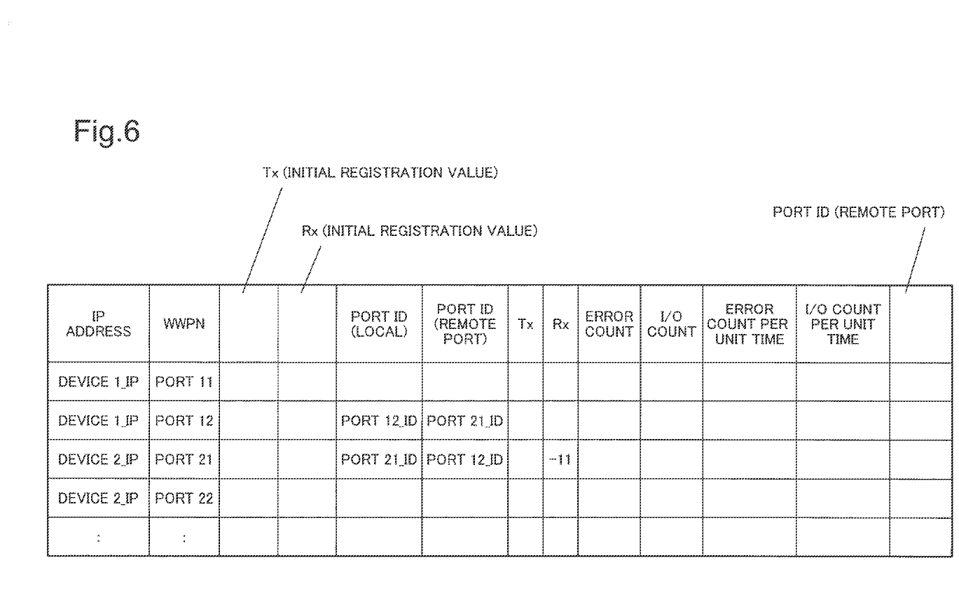

Device information collecting means 110b generates and updates a table stored in a management table 114b. One example of the table stored in the management table 114b is illustrated in FIG. 6. In the management table 114b in FIG. 6, the following information is stored in tabular form organized by WWPN (World Wide Port name).

IP address: IP address of device.

WWPN: WWPN of port, which is unique in the table.

Tx (initial registration value): Tx value (fixed value) at initial registration.

Rx (initial registration value): Rx value (fixed value) at initial registration.

Port ID (local): port ID of local port.

Port ID (remote): port ID of remote port.

Tx: power value (0 dB=1 mV) at sending end of media converter (SFP: Small Form factor Pluggable) of connection between optical cable and device.

Rx: power value (0 dB=1 mV) at receiving end of SFP.

Error count: error counter value held in device.

I/O count: counter value of I/O count held in device.

Error count per unit time: difference between current error count value obtained and previous error count value obtained.

I/O count per unit time: difference between current I/O count obtained and previous I/O count obtained.

Double-transmission flag: Boolean value, True or False. When the double-transmission instruction is applied, True is set; when the double-transmission instruction is not applied, False is set.

Tx and Rx are used in aging degradation monitoring. The error count and the I/O count are typically values of simple incremental counters. The error count per unit time and the I/O count per unit time are calculated on the basis of information stored in the management table 114b and are stored in the management table 114b. Further, when a port is not linked up, an invalid value is contained in its port ID cell. When the port ID is changed from the invalid value to a valid value, the management controller 800 detects that the port is linked up; when the port ID is changed from the valid value to the invalid value, the management controller 800 detects that the port is linked down.

The device 400 includes device information transmitting means 116c, double-transmission instructing means 118c, receiving means 117, 117c′, transmitting means 113c, 113c′, received frame holding means 119c, 119c′, and routing means 120c.

One device information transmitting means 116c, one double-transmission instructing means 118c and one routing means 120c are provided for the device 400. The receiving means 117c, 117c′, the transmitting means 113c, 113c′ and the received frame holding means 119c, 119c′ are provided for each of the ports of the device 400. The following description will focus on differences from the device 400 illustrated in FIG. 3 which is described in the second exemplary embodiment.

The transmitting means 113c uses the port 11 to transmit frames and transmitting means 113c′ uses the port 12 to transmit frames.

The receiving means 117c uses the port 11 to receive frames and receiving means 117′c uses the port 12 to receive frames.

The received frame holding means 119c, 119c′ hold header information of frames received by the receiving means 117c, 117c′, respectively.

The routing means 120c routes frames received from the ports 11, 12 to appropriate destination ports. The routing means 120c may be typical FC switches.

The device 500 is configured in the same way as the device 400.

Next, an operation of the data communication system 2000 will be described.

The device information collecting means 110b of the management controller 800 collects information about the states of the ports 11, 12, 21, 22 from the device information transmitting means 116c, 116d of the devices 400, 500 at regular intervals. The device information collecting means 110b extracts data corresponding to WWPNs included in the collected information from the management table 114b and updates the extracted data with the collected information.

“WWPN”, “Tx (initial registration value)”, and “Rx (initial registration value)” are not updated. “Error count” and “I/O count” are values of simple incremental counters. “Tx” and “Rx” directly contain values collected from each devices 400, 500. “Error count per unit time” and “I/O count per unit time” are updated with a calculated difference between an “error count” collected from each devices 400, 500 and an “error count” before the update and a difference between an “I/O count” collected from each devices 400, 500 and an “I/O count” before the update, respectively. When the “port ID (remote port)” collected from the devices 400, 500 is an invalid value, the value in the “double-transmission flag” is updated with “False”. Note that when data corresponding to WWPN included in collected information does not exist in the management table 114b, the device information collecting means 110b newly generates data for the WWPN. The “Tx (initial registration value)” and the “Rx (initial registration value)” of the newly generated WWPN contain a Tx value and am Rx value, respectively, collected from the devices 400, 500 and these values are set as fixed values. When aging degradation of a device, cable or the like is monitored, “Tx (initial registration value)” and “Rx (initial registration value” immediately after the device has been placed under the control of the management controller are compared with “Tx” and “Rx” in the subsequent operation. “Error count per unit time” and “I/O count per unit time” of newly generated WWPN contain the initial value “0” and “double-transmission flag” contains “False”.

When the management table 114b is updated by the device information collecting means 110b, the error occurrence predicting means 111b predicts the frequency of occurrence of transmission errors at each port on the basis of the updated information. For example, when information in the management table 114b meets any of conditions a, b and c given below, the error occurrence predicting means 111b determines that the frequency of occurrence of transmission errors at the port is more likely to increase than usual.

Condition a: value of “Rx” is less than or equal to a threshold (for example −10 dB).

Condition b: value of “Rx” is lower than “Rx (initial registration value)” by −3 dB.

Condition c: “error count per unit time” divided by “I/O per unit time” is outstanding among data associated with the same IP address.

When condition a is met, transmission performance is likely to be inadequate. When condition b is met, the device or cable has been aged. When condition c is met, the number of errors on a per I/O basis at a particular port is likely to be greater than the other ports in the same device.

Conditions a and b are for predictions based on monitoring of the status of device components and condition c is for prediction based on comparison between transmission error rates at the ports in the same device. The use of condition c enables prediction of a rise in the frequency of occurrence of transmission errors at a particular port by comparison of behavior of the particular port with the other ports even if the transmission error rate at the port does not exceed a threshold.

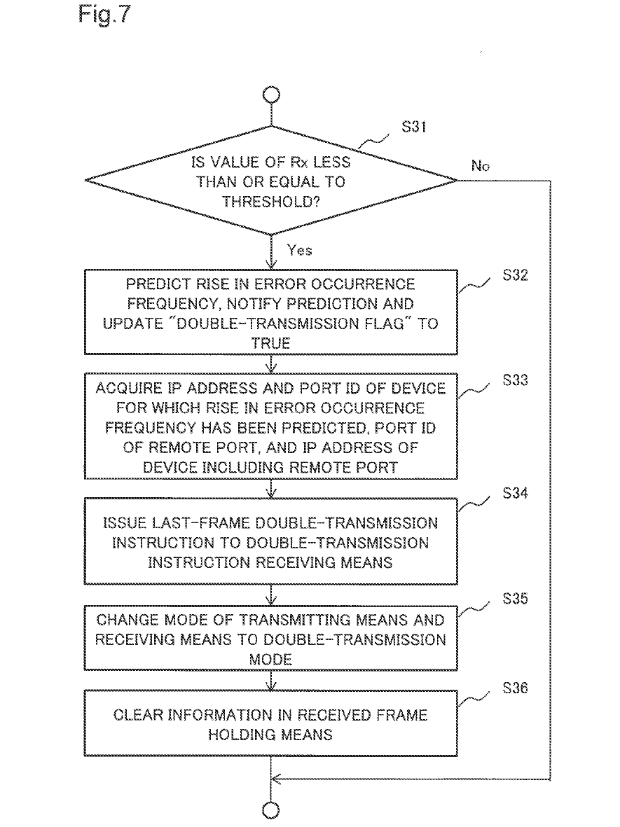

Next, an operation procedure of the data communication system 2000 when condition a (“Rx” is less than or equal to a threshold) is met will be described with reference to FIGS. 7 to 9. An operation of the management controller 800 will be described first with reference to FIG. 7.

When the error occurrence predicting means 111b checks the management table 114b and finds that the value of “Rx” of “WWPN=port 21” is “−11 dB”, the error occurrence predicting means 111b determines that condition a (“Rx” is less than or equal to a threshold) is met (Yes at step S31). When the error occurrence predicting means 111b predicts a rise in the frequency of occurrence of transmission errors at “WWPN=port 21”, the error occurrence predicting means 111b notifies the double-transmission instructing means 112b of the prediction and changes the value of “double-transmission flag” of “WWPN=port 21” to “True” (step S32).

The double-transmission instructing means 112b refers to the management table 114b to acquire the IP address (device 2_IP), the port ID (port 21_ID) of the local port and the port ID (port 12_ID) of the remote port that are associated with “WWPN=port 21”. The double-transmission instructing means 112b further extracts WWPN (port 12) whose port ID registered in “port ID (local)” is identical to the acquired port ID (port 12_ID) of the remote port from the management table 114b (step S33).

The double-transmission instructing means 112b issues a last-frame double transmission instruction for “port 21_ID” to the double-transmission instruction receiving means 118d of the device (device 500) having the IP address “device 2_IP” associated with WWPN (port 21) that meets condition a. The double-transmission instructing means 112b further issues a last-frame double-transmission instruction for “port 12_ID” to the double-transmission instruction receiving means 118c of the device (device 400) having the IP address “device 1_IP” associated with WWPN (port 12) extracted at step S33 (step S34).

The double-transmission instruction receiving means 118d of the device 500 changes the mode of the transmitting means 113d and the receiving means 117 that correspond to the port 21 to the double-transmission mode. Similarly, the double-transmission receiving means 118c of the device 400 changes the mode of the transmitting means 113c′ and the receiving means 117c′ that correspond to the port 12 to the double-transmission mode (step S35). This causes the port 12 and port 21 to enter the double-transmission mode.

After the ports 12 and 21 have entered the double-transmission mode, the receiving means 117c′ of the device 400 clears the information in the received frame holding means 119c′ and the receiving means 117d of the device 500 clears the information in the received frame holding means 119d (step S36).

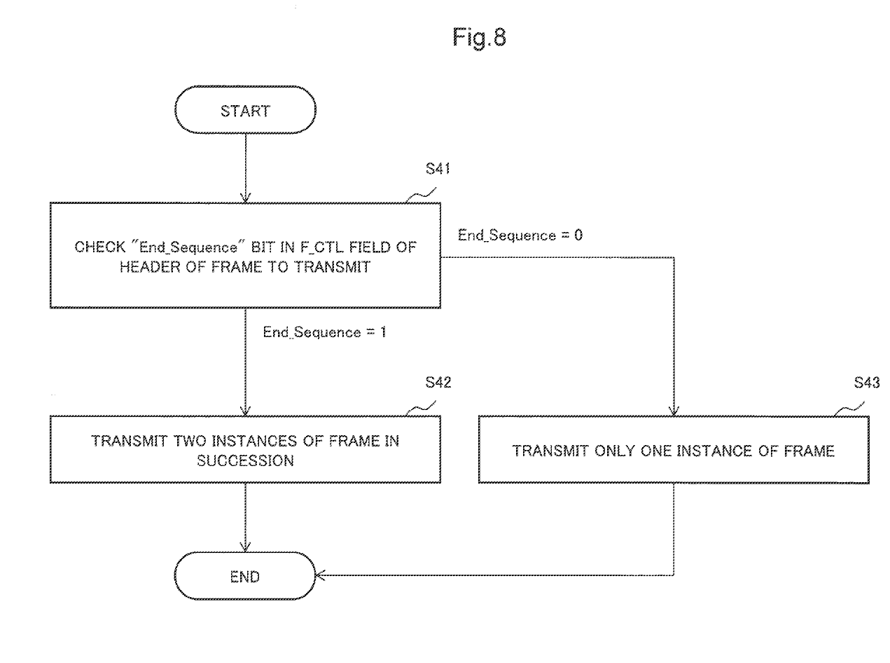

Next, an operation of the transmitting means 113c′ corresponding to the port 12 for which the double-transmission mode is set will be described with reference to FIG. 8. Note that the transmitting means 113d operates for the ports 12 and 21 for which the double-transmission mode is set in the same way as the transmitting means 113c′ does.

When the transmitting means 113c′ checks the “End_Sequence” bit in the F_CTL field of the header of a frame to be transmitted and finds that the “End_Sequence” bit in the F_CTL field is 1 (End_Sequence=1 at step S41), the transmitting means 113c′ transmits two instances of the frame in succession (step 42). On the other hand, when the “End_Sequence” bit in the F_CTL field is 0 (End_Sequence=0 at step S41), the transmitting means 113c′ transmits only one instance of the frame (step S43).

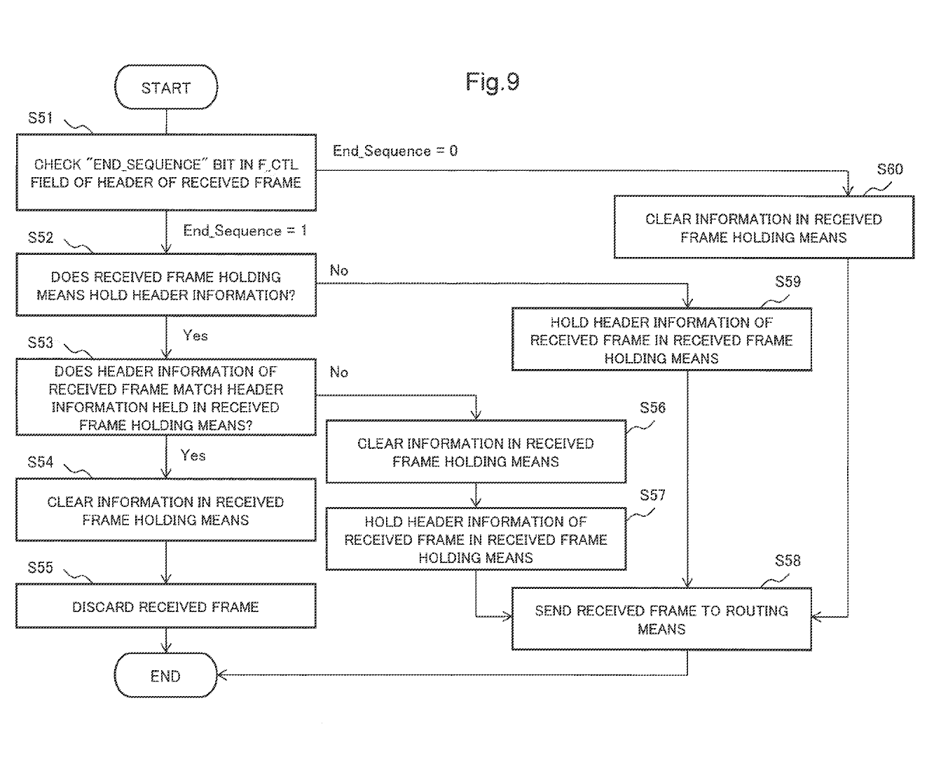

Next, an operation of the receiving means 117d corresponding to the port 21 for which the double-transmission mode is set will be described with reference to FIG. 9. Note that the transmitting means 113d operates for the ports 12 and 22 for which the double-transmission mode is set in the same way as the transmitting means 113c′ does. The receiving means 117c′ also operates in the same way as the receiving means 117d does.

The receiving means 117d checks the “End_Sequence” bit in the F_CTL field of the header of a received frame (step S51). If the “End_Sequence” bit is 1 (End_Sequence=1 at step S51) and the received frame holding means 119d holds header information (Yes at step S52), the receiving means 117d compares the header information of the received frame with the header information held in the received frame holding means 119d.

If both pieces of header information match (Yes at step S53), the receiving means 117d clears the information in the received frame holding means 119d (step S54) and discards the received frame (step S55). On the other hand, if the both pieces of header information do no match (No at step S53), the receiving means 117d clears the information in the received frame holding means 119d (step S56) and stores the header information of the received frame in the received frame holding means 119d (step S57). Furthermore, the receiving means 117d sends the received frame to the routing means 120d for routing to the destination port by a normal process (step S58).

On the other hand, if the “End_Sequence” bit of the header of the received frame is 1 at S51 (End_Sequence=1 at step S51) and the received frame holding means 119d does not hold header information at S52 (No at step 52), the receiving means 117d places the header information of the received frame in the received frame holding means 119d (step S59). The receiving means 117d then sends the received frame to the routing means 120d for routing to the destination port by a normal process (step S58).

If the “End_Sequence” bit is 0 at step S51 (End_Sequence=0 at step S51), the receiving means 117d clears the information in the received frame holding means 119d. Then the receiving means 117d sends the received frame to the routing means 120d for routing to the destination port by a normal process (step S60).

Note that the header information held in the received frame holding means 119d may be the entire frame header (24 bytes) or part of the header information (such as a combination of D_ID, S_ID, SEQ_ID, OX_ID and RX_ID) with which the uniqueness of the frame can be identified.

As a result of the operations described above, only transmission and reception of last frames between the ports 12 and 21 is doubled.

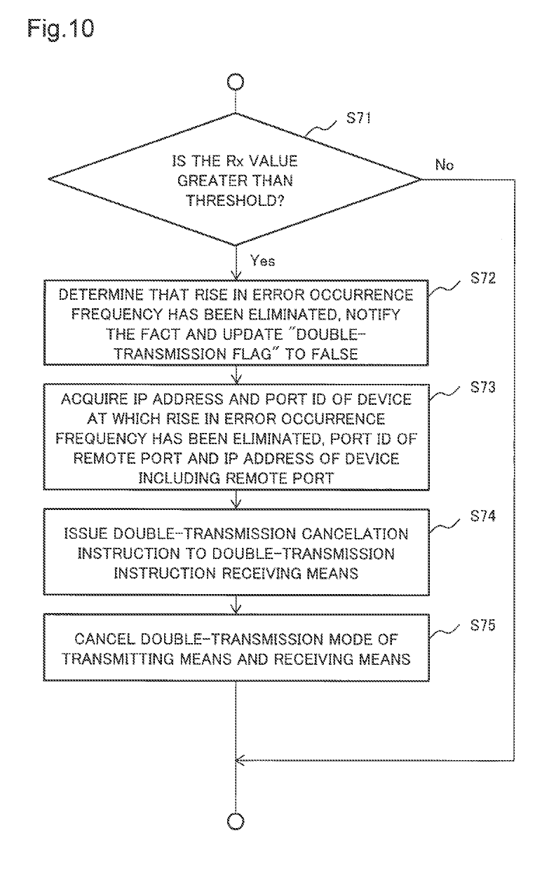

Next, an operation of the data communication system 2000 to end the last-frame double-transmission will be described with reference to FIG. 10.

In FIG. 10, when the error occurrence predicting means 111b checks the management table 114b and finds that the value of “Rx* of “WWWPN=port 21” for which “double-transmission flag=True” is set is for example “−9 dB” (Yes at step S71), the error occurrence predicting means 111b determines that the frequency of occurrence of transmission errors is back to normal. In this case, the error occurrence predicting means 111b notifies the double-transmission cancelation instructing means 115b of the fact and changes the value of the “double-transmission flag” of the entry of “WWPN=port 21” to False (step S72).

The cancelation instructing means 115b refers to the management table 114b to acquire the IP address (device 2_IP), the port ID (port 21 ID) of the local port, and the port ID (port 12_ID) of the remote port that are associated with “WWPN=port 21”. The cancelation instructing means 115b further extracts WWPN (port 12) whose port ID registered in “port ID (local)” is identical to the acquired port ID (port 12_ID) of the remote port from the management table 114b (step S73).

The cancelation instructing means 115b issues a double-transmission cancelation instruction for “port 21_ID” to the double-transmission instruction receiving means 118d of the device (device 500) having the IP address “device 2_IP” associated with WWPN (port 21) at which the frequency of occurrence of transmission errors is back to normal. The double-transmission instructing means 112b further issues a double-transmission cancelation instruction for “port 12_ID” to the double-transmission instruction receiving means 118c of the device (device 400) having the IP address “device 1_IP” associated with WWPN (port 12) extracted at step S73 (step S74).

The double-transmission instruction receiving means 118d of the device 500 cancels the double-transmission mode of the transmitting means 113d and the receiving means 117d that correspond to the port 21. Similarly, the double-transmission instruction receiving means 118c of the device 400 cancels the double-transmission mode of the transmitting means 113c′ and the receiving means 117c′ that correspond to the port 12 (step S75). With this, the last-frame double-transmission between the port 12 and the port 21 ends.

Note that when the double-transmission instruction receiving means 118c, 118d has not received the double-transmission cancelation instruction and any of the port 12 and port 21 operating in the double-transmission mode is linked down, the transmitting means 113c′, the receiving means 117c′, the transmitting means 113d and the receiving means 117d cancel the double-transmission mode.

When the “port ID (remote port)” in information received from the device information transmitting means 116c, 116d of the devices 400, 500 is an invalid value, the device information collecting means 110b of the management controller 800 determines that the double-transmission mode of the ports 12 and 21 are cancelled by link-down. The device information collecting means 110b changes the value of the “double-transmission flag” in the management table 114b to False.

The data communication system 2000 according to this exemplary embodiment predicts the likelihood of occurrence of frame losses due to a failure of a device or other factors before double transmission of a last frame. Accordingly, losses of last frames that can occur in the future and occurrence of no-response states caused by the losses of last frames can be reduced. Furthermore, doubly transmitting only the last frame only to a link on which a frame loss is likely to occur causes only minimal degradation of the transmission performance between the end nodes.

### Fourth Exemplary Embodiment

In a fourth exemplary embodiment, the data communication device 100 or the data communication system 2000 according to any of the first to third exemplary embodiments is applied to Rapid and Reliable Data Delivery (R2D2) used in layer 2 switches of Ethernet (registered trademark) networks and the like.

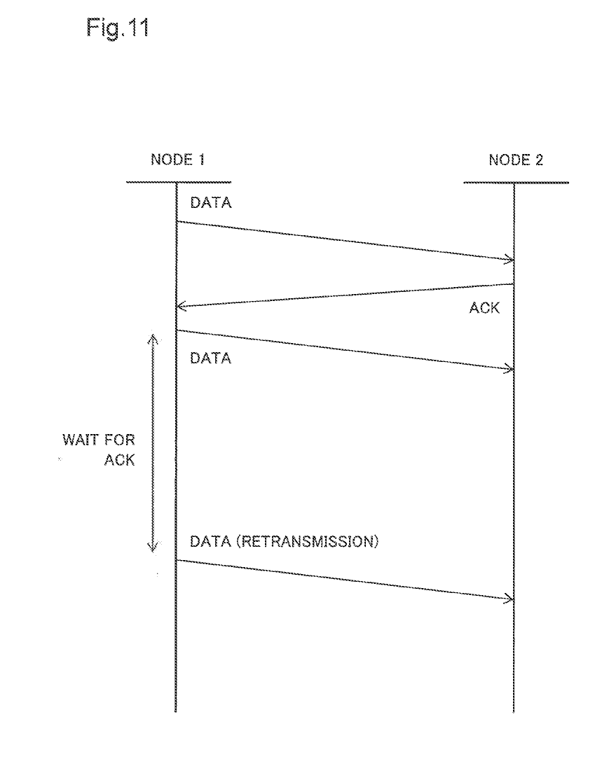

FIG. 11 is a diagram illustrating an example of data transmission flow in R2D2. R2D2 is a technique in which a unique ACK response is defined in MAC (Media Access Control) frame transmission between devices and fast retransmission is achieved by reception of a NACK (Negative ACKnowledgement) or timeout of an ACK wait state. However, because there is a slight ACK wait time, a problem arises when ACK is not sent back. This is equivalent to occurrence of a no-response state due to a last-frame loss in class 3 FC communication described above.

When retransmission due to NACK or timeout of an ACK wait state frequently occurs on a link between devices, the transmission quality of the link between the devices may have been degraded for some reason. To address this problem, in the data communication system according to this exemplary embodiment, data and ACK are doubly transmitted to the link when some transmission quality degradation is detected.

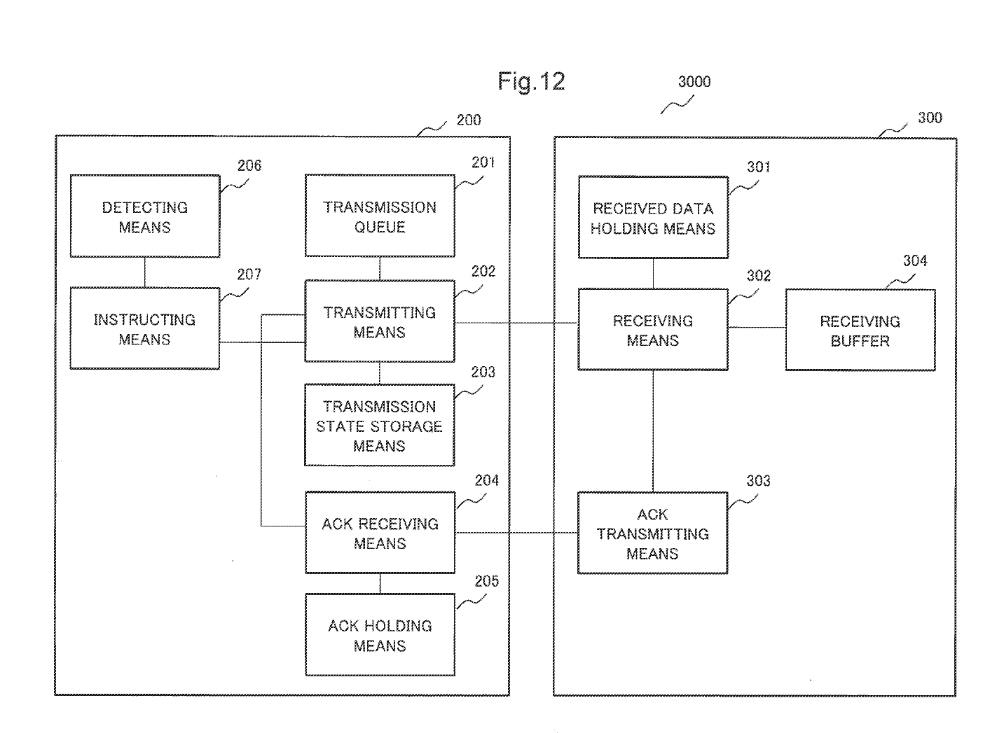

FIG. 12 illustrates a system configuration diagram of a data communication system 3000 according to this exemplary embodiment. Only the components that are required for transmitting data from a device 200 to a device 300 are depicted in FIG. 12. The devices 200 and 300 have similar functionality and are interconnected through an Ethernet network.

The device 200 includes a transmission queue 201, transmitting means 202, transmission state storage means 203, ACK receiving means 204, ACK holding means 205, detecting means 206 and instructing means 207.

The transmission queue 201 is a transmission queue of a typical layer 2 switch.

The transmitting means 202 transmits data in the transmission queue 201 to the device 300. When an ACK provided from the ACK receiving means 204 is a positive acknowledgement, the transmitting means 202 transmits the next data in the transmission queue 201. On the other hand, when the ACK response is a negative response, the transmitting means 202 retransmits the previously transmitted data. Furthermore, the transmitting means 202 retransmits the previously transmitted data after no notification has been received from the ACK receiving means 204 for a specified period of time.

The transmitting means 202 according to this exemplary embodiment notifies the transmission state storage means 203 that the transmitting means 202 has transmitted data. When the transmitting means 202 retransmits data after receiving NACK or after timeout of an ACK wait state, the transmitting means 202 notifies the transmission state storage means 203 of the retransmission. Furthermore, when a data double-transmission instruction is input from the instructing means 207, the transmitting means 202 according to this exemplary embodiment transmits two instances of the same data in succession. In the case of R2D2, the transmitting means 202 transmits two instances of every MAC frame and two instances of ACK corresponding to the MAC frame.

The transmission state storage means 203 holds the number of successful data transmissions and the number of retransmissions. The number of successful data transmissions is the number of transmissions of data that are not retransmissions and the number of retransmissions is the number of data retransmissions after reception of NACK or the number of ACK-wait-state timeouts at the transmitting means 202.

The ACK receiving means 204 receives an ACK packet transmitted from the ACK transmitting means 303 of the device 300. The ACK receiving means 204 compares the received ACK packet with information held in the ACK holding means 205. If the two do not match, the ACK receiving means 204 clears the information in the ACK holding means 205, stores the received ACK packet information in the ACK holding means 205, and notifies the transmitting means 202 of the type of the ACK (positive acknowledgement or negative acknowledgement). On the other hand, when the two match, the ACK receiving means 204 clears the information in the ACK holding means 205. In this case, the ACK receiving means 204 does not give notification to the transmitting means 202.

Information for identifying the uniqueness of the previous ACK packet received is stored in the ACK holding means 205. The entire ACK packet or only part of ACK packet information may be stored in the ACK holding means 205. Note that no information is stored in the ACK holding means 205 immediately after the startup of the device.

The detecting means 206 detects degradation in the transmission quality of a link between devices. For example, when retransmission due to NACK or timeout of ACK wait state frequently occurs, the detecting means 206 determines that the transmission quality of the link between the devices has been degraded and predicts a rise in the frequency of occurrence of transmission errors. Furthermore, when the ratio of the retransmission count to the successful data transmission count increases or when the retransmission count per unit time increases, the detecting means 206 according to this exemplary embodiment determines that the transmission quality of the link between the devices has been degraded and predicts a rise in the frequency of occurrence of transmission errors.

When a rise in the frequency of occurrence of transmission errors is predicted by the detecting means 206, the instructing means 207 sends a data double-transmission instruction to the transmitting means 202.

The device 300 includes received data holding means 301, receiving means 302, ACK transmitting means 303, and a receiving buffer 304.

Information (such as header information) for identifying the uniqueness of the previous data received is stored in the received data holding means 301. No information is stored in the received data holding means 301 immediately after startup of the device.

The receiving means 302 receives data transmitted from the transmitting means 202 of the device 200. The receiving means 302 compares the header information, for example, of the received data with header information stored in the received data holding means 301. If the two do not match, the receiving means 302 clears the header information stored in the received data holding means 301 and stores the header information of the newly received data in the received data holding means 301.

Furthermore, the receiving means 302 sends the received data to the receiving buffer 304 and issues an ACK (positive acknowledgement or negative acknowledgement) transmit instruction to the ACK transmitting means 303. On the other hand, if the two match, the receiving means 302 clears the information in the received data holding means 301 and issues an ACK (positive acknowledgement) transmit instruction to the ACK transmitting means 303. The receiving means 302 then discards the received data.

The ACK transmitting means 303 transmits an ACK packet to the device 200 in accordance with an instruction from the receiving means 302.

The receiving buffer 304 is a receiving buffer of a typical layer 2 switch.

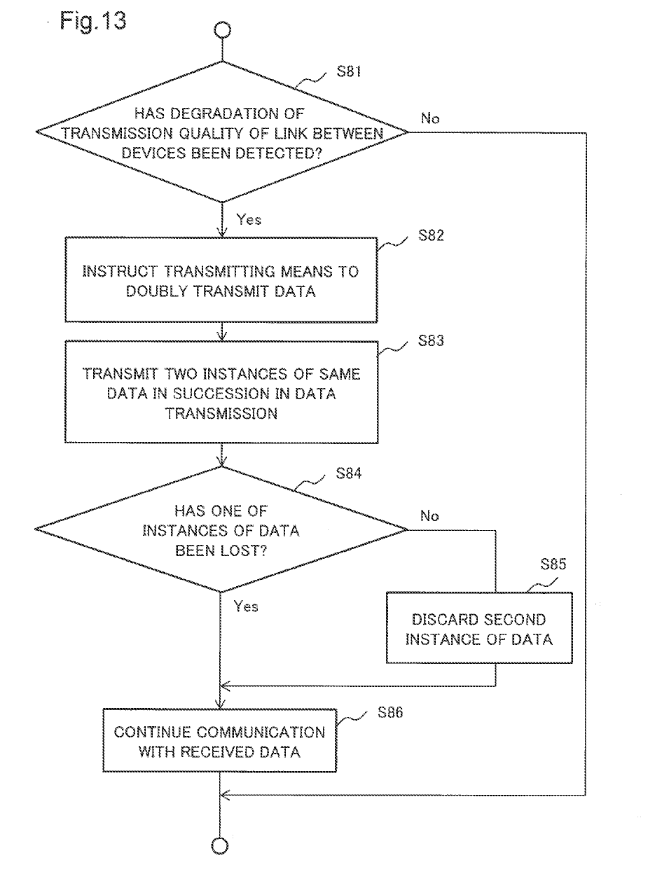

Next, operations of the devices 200, 300 performed when a rise in the frequency of occurrence of transmission errors is predicted by the detecting means 206 of the device 200 will be descried with reference to FIG. 13.

When the ratio of the retransmission count to the successful data transmission count increases or when the retransmission count per unit time increases, the detecting means 206 determines that the transmission quality of the link between the devices has been degraded (Yes at step S81). In this case, the instructing means 207 sends a data double-transmission instruction to the transmitting means 202 (step S82). This causes the transmitting means 202 to transmit the two instances of the same data in succession in data transmission from the device 200 to the device 300 (step S83).

If one of the first or second instances of data transmitted has been lost (Yes at step S84), the communication is continued with the received instance of the data (step S86). Then the device 200 receives one ACK packet to the received one of the instances of the data to continue the communication.

On the other hand, if both of the first and second instances data transmitted have not been lost (No at step S84), the second instance of the data received is discarded by the receiving means 302 (step S85). In this case, the device 300 receives two instances of the same data in succession and accordingly the device 200 receives two instances of an ACK packet from the device 300 in succession. The second instance of the ACK packet received is discarded by the ACK receiving means 204 of the device 200 and the communication is continued with the first instance of the ACK received (step S86).

When the rise in the ratio of the retransmission count to the successful data transmission count or the rise in the retransmission count per unit time has been eliminated, the detecting means 206 determines that the degradation in the transmission quality of the link between the devices has been eliminated. In this case, the instructing means 207 issues a data double-transmission disable instruction to the transmitting means 202. This causes the transmitting means 202 to discontinue the double transmission.

The data communication system 3000 according to this exemplary embodiment can reduce the frequency of occurrence of no-response states due to ACK wait states in R2D2 by applying the data communication device or the data communication system described with respect to the first to third exemplary embodiments to R2D2.

### Fifth Exemplary Embodiment

In a fifth exemplary embodiment, the data communication device 100 or the data communication system 2000 according to the first to third exemplary embodiment is applied to TCP (Transmission Control Protocol)/IP (Internet Protocol).

TCP does not include the concept of last frame in FC communication. However, TCP is a protocol in which ACK is defined and, when ACK is not sent back from the receiving end, the communication is suspended while waiting for ACK. This is equivalent to a no-response state due to last-frame loss in class 3 FC communication.

A data transmission flow in TCP/IP is similar to the data transmission flow in R2D2 illustrated in FIG. 11 which is described in the fourth exemplary embodiment. In FIG. 11, a node 1 retransmits a packet after the timeout of an ACK wait state. If the node 1 fails to receive ACK from a node 2 again, the node 1 typically increments the ACK wait state timer value and then retransmits the packet. Retransmission is repeated and, when the number of retransmissions exceeds a threshold, the connection is released.

This state is likely to frequently occur in an environment where the line quality is poor, such as a mobile environment, for example. This state appears to an application running on the node 1 to be a no-response state of the node 2. In the data communication system according to this exemplary embodiment, when the node 2 detects degradation in the line quality, the node 2 doubly transmits an ACK packet to avoid the state.

Specifically, when the frequency with which packet losses are detected by sequence number checking increases or the frequency with which packet crashes are detected by CRC (Cyclic Redundancy Check), the node 2 determines that the line quality has been degraded and starts double-transmission of ACK packets. The node 1 stores the ACK number of a received ACK packet and, when the node 1 newly receives an ACK packet that contains the same information as an ACK packet previously received, discards the newly received ACK packet. This can prevent degradation in communication performance due to ACK wait on a line of unstable communication quality, such as a mobile channel.

Note that while a method may be conceivable in which the node 1 initiates double transmission of data to the node 2 when degradation in the line quality at the node 1, such as an increase in the frequency of ACK wait timeouts or an increase in the number of retransmissions at the node 1, is detected, this method is likely to cause congestion. Therefore, only ACK packet transmission from the node 2 to the node 1 is doubled in this exemplary embodiment.

Furthermore, TCP does not include the concept of last frame in FC communication as noted above. However, when the last packet of a sequence of data stream transmitted has been lost, the sending end waits for ACK to the last packet and stops the communication. This is equivalent to occurrence of a no-response state due to a last-frame loss in class 3 FC communication.

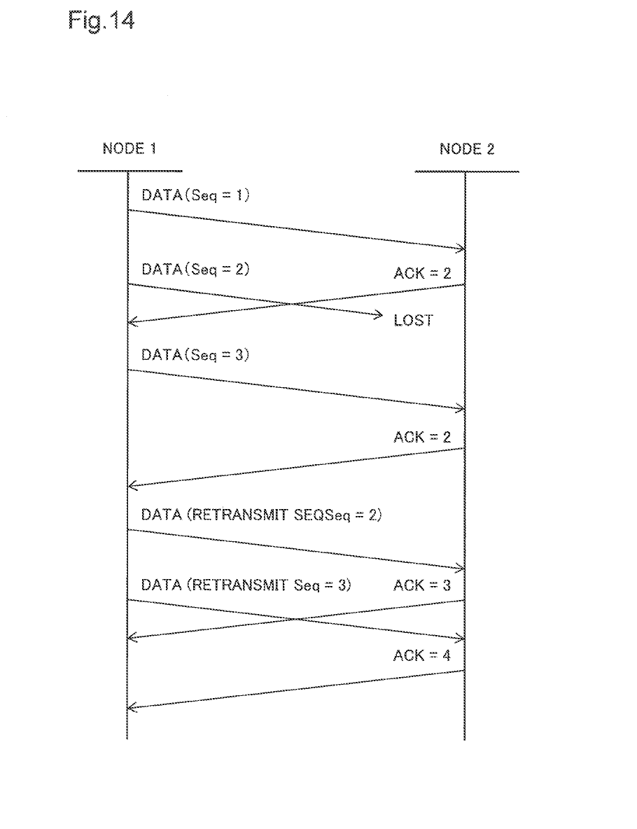

For example, consider a case where three packets are transmitted. When the second packet among the three packets transmitted from the node 1 has been lost as illustrated in FIG. 14, the node 1 finds that the second packet has been lost by referring to information in an ACK packet to the third packet. Consequently, the node 1 immediately performs retransmission starting with the second packet.

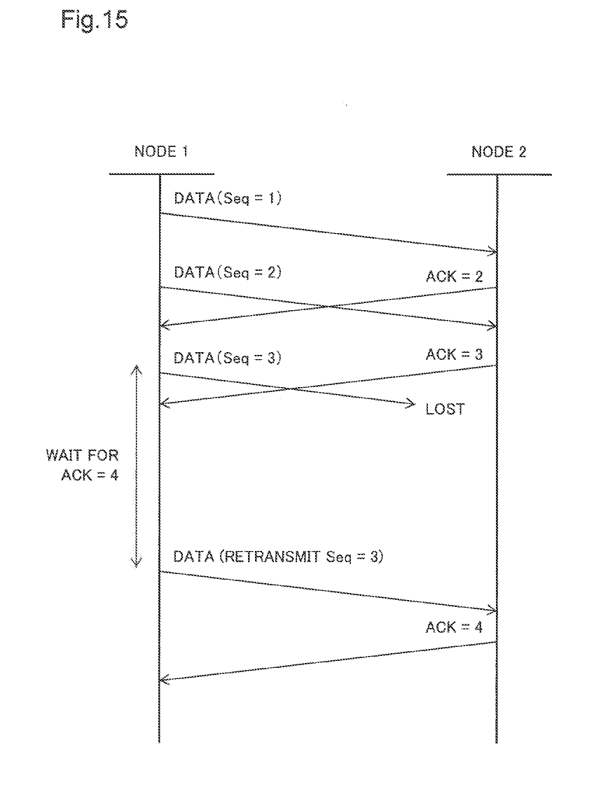

However, when the third packet among the three packets transmitted from the node 1 has been lost as illustrated in FIG. 15, the node 1 waits for ACK to the third packet and stops the communication. Degradation in the communication performance due to a last-packet loss as described above is likely to occur when frequent retransmissions are occurring in an environment where line quality is poor such as a mobile environment.

To avoid such a state, the node 1 transmits two instances of the last packet in a transmission buffer when line quality degradation, such as an increase in the number of ACK wait timeouts or an increase in the number of retransmissions, is detected at the node 1. When the node 2 receives two instances of a packet containing the same information, the node 2 discards the second packet.

In this way, occurrence of communication quality degradation due to ACK waits on a communication line of unstable communication quality, such as a mobile channel, for example, can be suppressed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

The whole or part of the exemplary embodiments disclosed above can be described as, but not limited to, the following supplementary notes.

(Supplementary note 1) A data communication device including transmitting means for transmitting a plurality of data strings for which sequential order is specified to another data communication device, the data communication device including: device information collecting means holding information about states of ports of the data communication device and the other data communication device; error occurrence predicting means for predicting a rise in the frequency of occurrence of transmission errors at each of the ports on the basis of information held by the information collecting means; and instructing means for instructing the transmitting means to transmit two or more instances of last data including a last data string when a rise in the frequency of occurrence of transmission errors is predicted by the error occurrence predicting means; wherein the transmitting means transmits two or more instances of the last data when the transmitting means receives the instruction from the instructing means.
(Supplementary note 2) The data communication device according to Supplementary note 1, wherein the error occurrence predicting means predicts a rise in the frequency of occurrence of transmission errors on the basis of at least any one of monitoring of states of components used in the data communication device and the other data communication device or comparison between transmission error rates at the ports.
(Supplementary note 3) The data communication device according to Supplementary note 1 or 2, further including receiving means for, when receiving two or more instances of the last data that contain the same information, holding one of the instances of the last data and discarding the rest of the instances of the last data.
(Supplementary note 4) The data communication device according to any one of Supplementary notes 1 to 3, further including a cancelation instructing means for instructing to cancel the instruction when the cancelation instructing means detects that the frequency of occurrence of transmission errors at a port corresponding to the transmitting means that has received the instruction is back to normal.
(Supplementary note 5) A data communication system including a data communication device and another data communication device, the data communication system including: device information collecting means holding information about states of ports of the data communication device and the other data communication device; error occurrence predicting means for predicting a rise in the frequency of occurrence of transmission errors at each of the ports on the basis of information held by the device information collecting means; and instructing means for, when a rise in the frequency of occurrence of transmission errors is predicted by the error occurrence predicting means, instructing the data communication device and the other data communication device to transmit two or more instances of last data including a last data string among a plurality of data strings for which sequential order is specified; wherein the data communication device and the other data communication device include transmitting means for transmitting the plurality of data strings and the data transmitting means transmits two or more instances of the last data when the data communication device and the other data communication device receive the instruction.
(Supplementary note 6) The data communication system according to Supplementary note 5, wherein the error occurrence predicting means predicts a rise in the frequency of occurrence of transmission errors on the basis of at least any one of monitoring of states of components used in the data communication device and the other data communication device or comparison between transmission error rates at the ports.
(Supplementary note 7) The data communication system according to Supplementary note 5 or 6, wherein a management controller provided separately from the data communication devices includes the device information collecting means, the error occurrence predicting means and the instructing means.
(Supplementary note 8) The data communication system according to any one of Supplementary notes 5 to 7, wherein the data communication device and the other data communication device further include receiving means for, when receiving two or more instances of the last data that contain the same information, holding one of the instances of the last data and discarding the rest of the instances of the last data.
(Supplementary note 9) The data communication system according to any one of Supplementary notes 5 to 8, wherein the management controller further includes cancelation instructing means for instructing to cancel the instruction when the error occurrence predicting means detects that the frequency of occurrence of transmission errors at a port for which a rise in the frequency of occurrence of transmission errors has been predicted is back to normal.
(Supplementary note 10) A data communication method in a data communication system including a data communication device and another data communication device, the data communication method including: an error occurrence predicting step of predicting a rise in the frequency of occurrence of transmission errors at ports of the data communication device and the other data communication device on the basis of information about states of the ports; an instructing step of, when a rise in the frequency of occurrence of transmission errors is predicted at the error occurrence predicting step, instructing to transmit two or more instances of last data including a last data string among a plurality of data strings for which sequential order is specified; and a transmitting step of transmitting two or more instances of the last data in response to the instruction.
(Supplementary note 11) The data communication method according to Supplementary note 10, wherein the error occurrence predicting step predicts a rise in the frequency of occurrence of transmission errors on the basis of at least any one of monitoring of states of components used in the data communication device and the other data communication device and comparison between transmission error rates at the ports.
(Supplementary note 12) The data communication method according to Supplementary note 10 or 11, further including a receiving step of, when two or more instances of the last data that contain the same information is received, holding one of the instances of the last data and discarding the rest of the instances of the last data.
(Supplementary note 13) The data communication method according to any one of Supplementary notes 10 to 12, wherein the error occurrence predicting step further includes a cancelation instructing step instructing to cancel the instruction when it is detected at the error occurrence predicting step that the frequency of occurrence of transmission errors at a port for which a rise in the frequency of occurrence of transmission error has been predicted is back to normal.

What is claimed is:

1. A data communication device comprising:
a plurality of ports for transmitting and receiving a plurality of data strings for which sequential order is specified;
transmitting means for transmitting the plurality of data strings through a predetermined port among the plurality of ports;
device information collecting means for collecting information about the plurality of ports and a plurality of ports of a remote device to and from which data strings are transmitted and received;
error occurrence predicting means for predicting the frequency of occurrence of transmission errors at each port on the basis of the collected information; and
instructing means for, when a port for which a rise in the frequency of occurrence of transmission errors has been predicted is detected, outputting a double-transmission instruction for the detected port to the transmitting means;
wherein when the double-transmission instruction is input, the transmitting means transmits two or more instances of last data of a plurality of data strings when the transmitting means transmits data strings through the detected port.

2. The data communication device according to claim 1, wherein the error occurrence predicting means predicts a rise in the frequency of occurrence of transmission errors on the basis of states of components used in the data communication device and the remote device or comparison between transmission error rates at the ports.

3. The data communication device according to claim 1, further comprising receiving means for, when receiving two or more instances of the same last data, holding the first received instance of the last data received and discarding the subsequently received instances of the last data received.

4. The data communication device according to claim 1, further comprising cancelation instructing means for, when the frequency of occurrence of transmission errors at a port for which the double-transmission instruction has been issued is back to normal, outputting a double-transmission cancelation instruction for the port for which the double-transmission instruction has been issued to the transmitting means.

5. A data communication system comprising:
a first data communication device and a second data communication device, each of the first and second data communication devices comprising a plurality of ports for transmitting and receiving a plurality of data strings for which sequential order is specified; and
a management controller comprising:
device information collecting means for collecting information about the plurality of ports of the first data communication device and the second data communication device;
error occurrence predicting means for predicting the frequency of occurrence of transmission errors at each of the plurality of ports of the first data communication device and the second data communication device on the basis of the collected information; and
instructing means for, when a port for which a rise in the frequency of occurrence of transmission errors has been predicted is detected, transmitting a double-transmission instruction for the detected port to the data communication device including the detected port;
wherein the data communication device that has received the double-transmission instruction transmits two or more instances of last data of a plurality of data strings when transmitting data strings through the detected port.

6. The data communication system according to claim 5,
wherein the management controller further comprises holding means for holding the collected information for each of the plurality of ports of the first and second data communication devices;
a corresponding port for each of the plurality of ports is registered in the holding means;
the error occurrence predicting means predicts the frequency of occurrence of transmission errors on the basis of information registered in the holding means and information newly collected by the device information collecting means; and
the instructing means extracts a corresponding port corresponding to the detected port from the holding means and transmits a double-transmission instruction to the data communication device including the detected port and the data communication device including the extracted corresponding port.

7. The data communication system according to claim 5, wherein the error occurrence predicting means predicts a rise in the frequency of occurrence of transmission errors on the basis of states of components used in the first and second data communication devices or comparison between transmission error rates at each of the ports.

8. The data communication system according to claim 5, wherein when the first and second data communication devices receive two or more instances of the same last data, the first and second data communication devices hold the first receive instance of the last data and discard the subsequently received instances of the last data.

9. The data communication system according to claim 5, further comprising cancelation instructing means for, when the frequency of occurrence of transmission errors at a port for which the double-transmission instruction has been issued is back to normal, transmitting a double-transmission cancelation instruction for the port for which the double-transmission instruction has been issued to the data communication device to which the double-transmission instruction has been transmitted.

10. A data communication method for transmitting and receiving a plurality of data strings for which sequential order is specified through a predetermined port among a plurality of ports, the communication method comprising:
collecting information about the plurality of ports;
predicting the frequency of occurrence of transmission errors for each of the ports on the basis of the collected information;
when a port for which a rise in the frequency of occurrence or transmission errors has been predicted is detected, setting a double-transmission instruction for the detected port; and
when data strings are transmitted through the port for which the double-transmission instruction is set, transmitting two or more instances of last data of a plurality of data strings.
